(19) United States
(12) Patent Application Publication
(10) Pub. No.: US 2026/0093709 A1
(43) Pub. Date: Apr. 2, 2026

(54) SECURITY DATA INGESTION AND PROCESSING

(71) Applicant: Lucidum Inc., Cincinnati, OH (US)

(72) Inventors: Joel M. Fulton, Cincinnati, OH (US); Jeremy Sherwood, Beaverton, OR (US); Shuning Wu, Mountain View, CA (US); Joseph Giles, Fuquay-Varina, NC (US)

(21) Appl. No.: 18/889,674

(22) Filed: Sep. 19, 2024

(51) Int. Cl. G06F 16/25

(52) U.S. Cl. CPC G06F 16/258

(57) ABSTRACT

Methods, systems, and devices for security data ingestion and processing at a data security system are described. The data security system may obtain data files from multiple security data sources which may have multiple input formats. The data security system may extract information from the obtained data files and may store the extracted information in one or more databases in format(s) compatible with the one or more databases. The data security system may output information retrieved from the one or more databases to a computing device for display at the computing device via an application programming interface (API). The data security system may convert the information from the storage format(s) associated with the one or more databases to a format compatible with the API (e.g., for display at the computing device). The data security system may perform data processing on the information stored at the one or more databases.

### FIELD OF TECHNOLOGY

The present disclosure relates generally to database systems and data processing, and more specifically to security data ingestion and processing.

### BACKGROUND

A data security system may be employed to detect and manage data security risks associated with one or more computing assets. The data monitored by the data security system may be generated, stored, or otherwise used by the one or more computing assets, examples of which may include mobile phones, tablet computers, personal computers, servers, databases, virtual machines, cloud computing systems, file systems (e.g., network-attached storage (NAS) systems), or other data storage or processing systems. For example, a data security system may monitor for malware and/or suspicious activity within the one or more computing assets. In some examples, a data security system may receive indications of known types of malware from one or more malware information sources. The data security system may monitor the one or more computing assets for the known types of malware.

### BRIEF DESCRIPTION OF THE DRAWINGS

FIG. 1 illustrates an example of a computing environment that supports security data ingestion and processing in accordance with aspects of the present disclosure.

FIG. 2 shows an example of a security data pipeline that supports security data ingestion and processing in accordance with aspects of the present disclosure.

FIG. 3 shows an example of a user interface view that supports security data ingestion and processing in accordance with aspects of the present disclosure.

FIG. 4 shows an example of a process flow that supports security data ingestion and processing in accordance with aspects of the present disclosure.

FIG. 5 shows a block diagram of a data security system controller that supports security data ingestion and processing in accordance with aspects of the present disclosure.

FIG. 6 shows a diagram of a system including a device that supports security data ingestion and processing in accordance with aspects of the present disclosure.

FIGS. 7 through 10 show flowcharts illustrating methods that support security data ingestion and processing in accordance with aspects of the present disclosure.

### DETAILED DESCRIPTION

A data security system may be employed to monitor for and manage data security risks associated with one or more computing or assets. For example, the one or more computing assets may be associated with an entity which may be a customer or subscriber of the data security system. For example, an entity may be an individual or an organization. A computing asset may be any device, physical or virtual, capable of processing, storing, transmitting, and/or receiving data. For example, a computing asset may be a stationary device (e.g., a desktop computer or access point) or a mobile device (e.g., a laptop computer, a tablet computer, or a smart phone). As another example, a computing asset may be a commercial computing device, such as a server or collection of servers. In some examples, a computing asset may be a virtual device (e.g., a virtual machine). In some examples, the data security system may scan (e.g., periodically or on-demand) or may otherwise monitor for security risks based on computing objects (e.g., files, software applications, or any other programming elements) stored at or accessible to the computing assets. For example, the data security system may store a listing of known malware, and the data security system may monitor for the known malware within the computing assets monitored by the data security system. As another example, a data security system may monitor for suspicious activity on or associated with one or more computing assets. For example, the data security system may track which user accounts access and/or otherwise use computing assets, and the data security system may track unauthorized access to computing assets or computing resources.

In some cases, the data security system may be responsible for hundreds or thousands of physical and virtual computing assets across multiple networks that may collectively generate thousands or millions of data files. For example, data files may include incident reports for the detection of suspicious activity or malware. As another example, a data file may include the addition of a computing asset to an organization or a network. As another example, a data file may include information such as records of scans of computing assets (e.g., which may or may not reveal suspicious activity). As another example, a data file may record or involve an action performed by the data security system, such as blocking the download of a virus or removal of a virus or malware from a computing asset. The data security system may store data records for monitored organizations (e.g., based on data from files generated or obtained in association with monitoring computing assets) in one or more databases.

In some examples, the data security system may receive data files, such as event logs or data records, from multiple data information sources (e.g., which may also be referred to as security data sources). For example, a malware protection program may generate data files, for example, based on scans of computing assets. As another example, an access control system may generate data files based on users accessing computing assets monitored by the data security system. As another example, different types of computing assets may user different malware protection programs (e.g., a first malware protection program may manage computing assets that use a first operating system and a second malware protection may manage computing assets that use a second operating system), which may each generate data files. The different data information sources may provide data files to the data security system in different formats (e.g., in different file formats or different data/structure formats). The data security system may store data obtained from the data files provided by the multiple data sources into one or more storage environments (e.g., cloud storage or local storage nodes). Different storage environments may store data in different formats (e.g., a SQL database may store information in a tabular format while a non-SQL database may store information in a non-tabular format). As another example, different cloud storage vendors may use different storage formats. Accordingly, aspects of the current disclosure may involve conversion, by a data security system, of information in data files received by the data security system from one or more data information sources into a format that is compatible with a particular storage environment. In some examples, the data security system may extract information from data files obtained from the data information sources (e.g., the extracted information may be relevant for data security purposes while some data from the data files may be discarded). In some examples, the data security system may store the information from the data files in multiple storage environments, and the data security system may convert the information stored in each of the multiple storage environments to a respective format for each of the multiple storage environments.

In some examples, the data security system may perform data processing on the collected and/or stored information for purposes such as extraction of relevant data, classification of data, identification of patterns or anomalies in the collected information, or prediction of future threats or events. For example, the data security system may perform machine learning based data processing on collected or stored data using a trained machine learning model or algorithm. Inputs to data processing models or algorithms may be formatted based on the type of data processing model or algorithm, and the output of the data processing model may be stored in a data storage environment. As another example, the output of a data processing model may be provided to a computing device (e.g., for display to an administrative user of the data security system) via an application programming interface (API). Accordingly, aspects of the current disclosure may involve the conversion of information stored in one or more storage environments from a storage format to a format compatible with an input to a data processing model. Further, aspects of the disclosure may relate to conversion of an output of a data processing model from an output format to a format compatible with a storage environment and/or a format compatible with an API.

As described herein, an administrative user of the data security system (e.g., an information technology (IT) specialist or a security officer or agent of a customer organization of the data security system), may analyze information collected and/or processed by the data security system to respond to events and/or threats. Accordingly, one or more APIs may be used to retrieve information stored in storage environments associated with the data security system and to display the retrieved information on a user interface of a computing device associated with the administrative user. APIs may use particular data formats to provide information to a computing device (e.g., for display at the computing device). The data format used by an API may be different from the data formats used to store information in data storage environments associated with the data security system. Further, the API may retrieve information from multiple data stores which may each have a different data storage format. Accordingly, aspects of the current disclosure may involve the conversion of information stored in one or more data stores (e.g., databases) to a format compatible with an API. Further, a data security system may use different APIs to provide different types of information and/or for different computing devices or applications. The different APIs may use different data formats. Accordingly, aspects of the current disclosure may involve the conversion of information stored in one or more data stores (e.g., databases) to a format compatible with a particular API.

Accordingly, a data security system as described in accordance with aspects of the present disclosure may flexibly store data obtained in data files of multiple formats from multiple data information sources in one or more storage environments (e.g., databases or other data stores) in format(s) compatible with the one or more storage environments. The data security system may flexibly perform data processing on data stored in one or more data storage environments and may store the output of the data processing in one or more data storage environments. The data security system may flexibly retrieve the data stored in the one or more storage environments and may be displayed at a user device (e.g., a computing device via one or more APIs for use by an administrative user of the data security system.

Aspects of the disclosure are initially described in the context of a computing environment supporting an on-demand database service. Aspects of the disclosure are further illustrated by and described with reference to security data pipelines, UI views, process flows, apparatus diagrams, system diagrams, and flowcharts that relate to security data ingestion and processing.

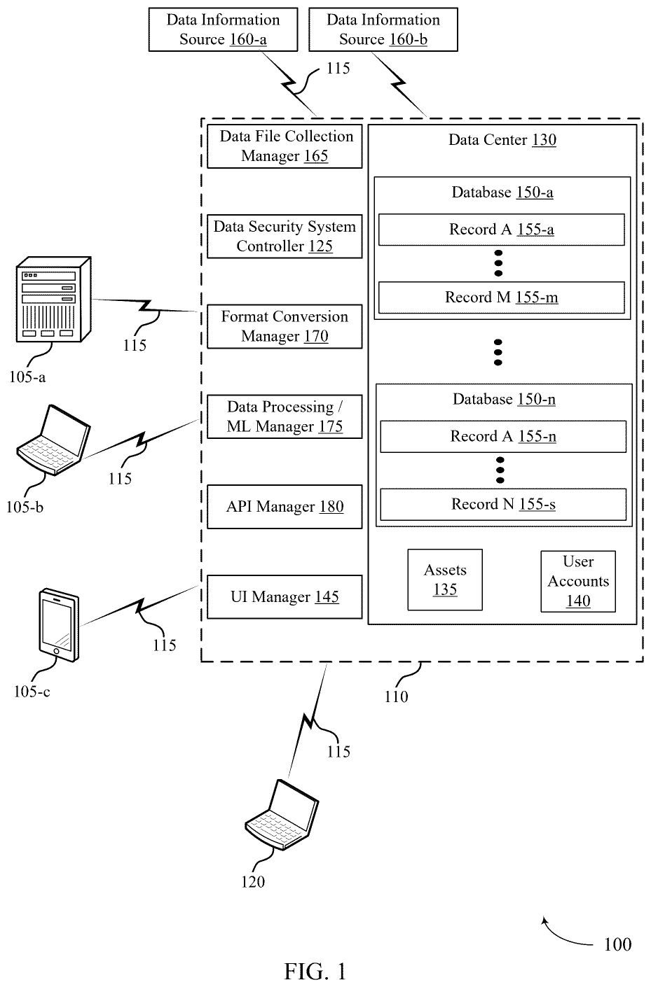

FIG. 1 illustrates an example of a computing environment 100 that supports security data ingestion and processing in accordance with aspects of the present disclosure.

The computing environment 100 includes one or more computing assets 105 (e.g., a computing asset 105-a, a computing asset 105-b, and a computing asset 105-c) that are monitored or protected by a data security system 110. Although shown as three computing assets 105, the data security system 110 may monitor any quantity of computing assets. The data security system 110 may communicate with the one or more computing assets 105 via communication links 115 (e.g., via a network connection). For example, the network may implement transfer control protocol and internet protocol (TCP/IP), such as the Internet, or may implement other network protocols. For example, the communication links 115 may include aspects of one or more wired networks (e.g., the Internet), one or more wireless networks (e.g., cellular networks), or any combination thereof. The communication links 115 may include aspects of one or more public networks or private networks, as well as secured or unsecured networks, or any combination thereof. The communication links 115 also may include any quantity of communication links and any quantity of hubs, bridges, routers, switches, ports or other physical or logical network components.

As described herein, a computing asset 105 may be any device, physical or virtual, capable of analyzing, storing, generating, and transmitting or receiving data. For example, a computing asset 105 may be a desktop computer, an access point, a personal digital assistant (PDA), a laptop computer, a tablet computer, a smartphone, a server, a collection of servers, a database, a data store, a virtual machine, or any combination thereof.

For example, a virtual machine may run various applications, such as a database server, an application server, or a web server. For example, a server may be used to host (e.g., create, manage) one or more virtual machines, and a computing system manager may manage a virtualized infrastructure within a computing system and perform management operations associated with the virtualized infrastructure. A computing system manager may manage the provisioning of virtual machines running within the virtualized infrastructure and provide an interface to a computing asset 105 interacting with the virtualized infrastructure. For example, the computing system manager may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of a disk of a computing system, the memory of a computing system, the processor of a computing system, the network interface of a computing system, the data storage device of a computing system, or any combination thereof in support of running the various applications. Storage resource that are virtualized may be accessed by applications as a virtual disk.

The data security system 110 may be implemented on one or more servers. The data security system 110 may include a data center 130 (e.g., one or more databases) that may include one or more servers. For example, a server may allow a client (e.g., a computing asset 105 or the data security system controller 125) to download information or files (e.g., executable, text, application, audio, image, or video files) from the server, to upload such information or files to the server, or to perform a search query related to particular information stored by the server. In general, a server may refer to one or more hardware devices that act as the host in a client-server relationship or a software process that shares a resource with or performs work for one or more clients The data center 130 may be used for data storage, management, and processing. The data center 130 may utilize multiple redundancies for security purposes. In some cases, the data stored at data center 130 may be backed up by copies of the data at a different data center (not pictured). Although shown as co-located with the data security system 110, one or more of the databases 150 of the data center may be separate from the data security system 110 (e.g., may be cloud storage environments or local storage environments such as a node cluster separate from but accessible to the data security system 110).

The data security system 110 may include a data security system controller 125, a UI manager 145, a format conversion manager 170, a data processing/machine learning manager 175, and an API manager 180. The data security system controller 125 may manage operation of the data security system 110, including the data center 130, the UI manager 145, the format conversion manager 170, the data processing/machine learning manager 175, and the API manager 180. Though illustrated as a separate entity within the data security system 110, the data security system controller 125 may in some cases be implemented (e.g., as a software application) by one or more of servers of the data center 130. Though illustrated as a separate entities, one or more of the UI manager 145, the format conversion manager 170, the data processing/machine learning manager 175, and the API manager 180 may be implemented (e.g., as a software application) by the data security system controller 125.

In some examples, an administrative user of the data security system 110 may interact with the data security system 110 using a computing device 120. The computing device 120 may be a user device or user endpoint that may be used to input information to or receive information from the data security system 110. In some examples, the computing device 120 may be a computing asset 105 monitored by the data security system 110. A user of the computing device 120 may provide user inputs via the computing device 120, which may result in commands, data, or any combination thereof being communicated via the communication link 115 to the data security system 110. A user of a computing device 120 may, for example, use the computing device 120 to interact with one or more UIs (e.g., graphical user interfaces (GUIs)) to operate or otherwise interact with the data security system 110.

In some examples, the data security system 110, or aspects thereof, may be implemented within one or more cloud computing environments, which may alternatively be referred to as cloud environments. Cloud computing may refer to Internet-based computing, where shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the data security system 110, or aspects thereof, for example, through Software-as-a-Service (SaaS) or Infrastructureas-a-Service (IaaS) services provided by the cloud environment. SaaS may refer to a software distribution model in which applications are hosted by a service provider and made available to one or more client devices over a network (e.g., to one or more computing assets 105 over the communication links 115). IaaS may refer to a service in which physical computing resources are used to instantiate one or more virtual machines, the resources of which are made available to one or more client devices over a network (e.g., to one or more computing assets 105 over the communication links 115)

As described herein, the data security system 110 may provide data/information security services to the computing assets 105. For example, the computing assets 105 may be associated with one or more customers of the data security system 110. For example, the data security system 110 may store (e.g., in the data center 130), a listing of known malware. The data security system 110 may scan the computing assets 105 (e.g., periodically or on-demand) for malware based on the listing of known malware. In some examples, the data file collection manager 165 may receive data files that may include logs of scan events for malware scans. As another example, the data security system 110 may monitor for suspicious activity (e.g., unauthorized access to a computing device by a user account or downloading of suspicious software such are viruses or other malware). For example, the data center 130 may store user account information in a user account listing 140 which may indicate permissions for user accounts associated with an entity for computing assets 105 associated with the entity. In some examples, the data file collection manager 165 may receive data files (e.g., log files) indicating when a particular user account accesses a particular computing asset 105.

The data security system 110 may be responsible for hundreds or thousands of physical and virtual computing assets 105 across multiple networks that may collectively generate thousands or millions of data files (e.g., event logs or data records). Additionally, or alternatively, the data security system 110 may receive data files from one or more data information sources 160. For example, a data information source 160 may be a malware monitoring system locally installed on a computing asset 105 or a third-party cloud-based malware monitoring system. As another example, a data information source 160 may be an access management system, for example implemented by a customer of the data security system 110, which may monitor which user accounts access which computing assets. Although shown as two data information sources 160 (e.g., a data information source 160 and a data information source 160-b) the data security system 110 (e.g., the data file collection manager 165) may obtain data files (e.g., indicative of event information) from any quantity of data information sources 160. As another example, a data information source 160 may be a cloud vendor which may provide virtual machine instance records (e.g., for virtual machine computing assets hosted by the cloud vendor). In some aspects, multiple data sources 160 may be multiple cloud vendors which may host virtual machine instances.

In some examples, data information sources 160 may be internal to the data security system 110 (e.g., the data security system 110 may generate data files when performing actions such as scanning for malware or blocking the download of a virus). As another example, the data security system 110 may generate or may obtain a data file when a new computing asset 105 is added to or removed from an organization or network monitored by the data security system 110. For example, the data security system 110 may store a computing asset listing 135 in the data center 130 which may store information (e.g., included computing asset IDs) for monitored computing assets 105.

The data file collection manager 165 may collect data files from the multiple data information sources 160 and may schedule the storage of information from the collected data files in one or more databases 150 (e.g., a database 150-a,. a database 150-n). Each database 150 of the one or more databases 150 may store data records 155 in a particular format associated with the particular database. For example, the database 150-a may store data record 155-a, . . . , and data record 155-m. The database 150-n may store data record 155-n, . . . , and data record 155-s. The data files collected from the multiple data information sources 160 may be obtained by the data file collection manager 165 in multiple formats. For example, each data information source 160 may provide data files in a different format (e.g., a malware monitoring system locally installed on a computing asset 105 may provide scan log files in a first file format and an access management system may provide access log event files in a second, different file format). Additionally, or alternatively, a same data information source 160 may provide data files in different formats depending on the type of event and/or information included in the data file. For example, a malware monitoring system may provide a first data file in a first format that includes information related to a scan of a particular computing asset 105, and the malware monitoring system may provide a second data file in a second format that includes a summary report of scans performed for multiple computing assets 105. As another example, a data information source 160 may be a source of information on common vulnerabilities and exposures (CVEs) (e.g., a public source of information such as the National Vulnerability Database (NVD) from the National Institute of Standards and Technology (NIST), a known exploited vulnerabilities (KEV) catalog from the Cybersecurity and Infrastructure Security Agency (CISA), an Exploit Prediction Scoring System (EPSS) catalog from the Forum of Incident Response and Security Teams, or any other CVE data source). For example, the data security system 110 may store data records 155 that include information relating to CVEs. As another example, a data information source 160 may be any other source of information on known malware or threats (e.g., subscription services, publicly available listings of known malware), for which the data security system 110 may store data records 155. For example, the data security system 110 may store data records 155 of CVEs or other known malware or threats in order to identify such CVEs, malware, or threats on monitored computing assets and/or to block the downloading of software or any other compute object associated with the CVEs, malware, or threats.

The format conversion manager 170 may convert information received in data files from the from the multiple data information sources 160 to data records 155 in formats compatible with the particular database 150 in which the data records 155 are stored. For example, the format conversion manager may include one or more abstraction layers which may convert information from one format to another format. For example, abstraction layers may be data abstractions that may define how data should be formatted. Each abstraction (also referred to as a “shim”) may define a schema for how data output by that abstraction layer should be formatted such that the output data may be processed by a downstream module or device (e.g., a database 150 mat be a downstream module or device for the abstraction layer that converts information from data files obtained by the data file collection manager 165 to data records 155). Use of abstraction layers may enable the data security system 110 to support multiple types of databases 150 (e.g., multiple data store vendors) at each step in the data pipeline of the data security system 110. For example, a first database 150 may be a an Amazon Web Services (AWS) Simple Storage Service (S3) database, and another database may be a SQL database or noSQL database. Along with a schema, this abstraction performed by an abstraction layer may be responsible for storing the structured data (e.g., structured by the abstraction layer) into a target datastore. For example, an abstraction layer for a NoSQL database may transform JSON data into NoSQL database documents and may insert those documents into a NoSQL database instance.

In some examples, the data file collection manager 165 may extract information (e.g., particular fields) from received data files, and the format conversion manager 170 may convert the extracted information into a data record 155 in the format compatible with the target database. For example, data files obtained by the data file collection manager 165 may include extraneous computer-generated fields and/or strings, and the data file collection manager 165 may extract the relevant fields for data security purposes such as the computing asset identifier (e.g., hostname, fully qualified domain name, medium access control (MAC) address, internet protocol (IP) address, or serial number), identifiers for associated user accounts, and event-type information (e.g., error strings, scan log information, access log information, malware or CVE type information, or the like). Extraction of relevant information from the data files (e.g., the relevant fields) may allow the data security to reduce the amount of data stored in the databases 150 and/or to more efficiently search for particular information (e.g., based on fields and based on a reduced total amount of data to search in the databases 150).

In some examples, the data security system 110 may store information in multiple databases 150. For example, information from particular types of data files, associated with particular computing assets, associated with particular user accounts, or received from particular data information sources 160 may be stored in particular databases 150. For example, information extracted from data files received from the data information source 160-a may be stored in the database 150-a, and information extracted from data files received from the data information source 160-b may be stored in a different database 150. As another example, information extracted from data files that are associated with a first user account or a first computing asset may be stored in the database 150-a, and information extracted from data files that are associated with a second user account or a second computing asset may be stored in a different database 150. As another example, information extracted from malware scan logs may be stored in the database 150-a and information extracted from CVE reports may be stored in a different database. In some examples, data records may be stored in multiple databases 150 for redundancy purposes.

As data records 155 extracted from information in data files obtained by the data file collection manager 165 may be stored in multiple databases 150, and each database may have a corresponding data record format, the format conversion manager 170 may convert information extracted from the data files obtained by the data file collection manager 165 into data records 155 in formats compatible with the particular database 150 in which the data records 155 are stored.

In some examples, the data security system 110 may perform data processing on information stored as data records in one or more of the databases 150. For example, the data security system 110 may perform data processing for purposes such as such as extraction of relevant data, classification of data, identification of patterns or anomalies in the collected information, summary of data, or prediction of future threats or events. For example, the data processing/machine learning manager 175 may perform data processing on information input to the data processing/machine learning manager 175 and may generate an output. In some examples, the output of the data processing/machine learning manager 175 may be directly presented to an administrative user at the computing device 120. For example, the output may be provided via an API to the computing device 120, and the API may be called based on an API manager 180. The UI manager 145 may control display of the output and/or may receive the request for the information output from the data processing/machine learning manager 175. In some examples, the data security system 110 may store the output of the data processing/machine learning manager 175 in a database 150. In some examples, the data security system 110 may use multiple data processing or machine learning models, and the data processing/machine learning manager 175 may manage (e.g., may manage the input to and output from) the multiple data processing or machine learning models. The formats of the input and/or output of the data processing or machine learning models may be different from the formats of the data records in the database and/or the format of information output by the API manager 180 to the computing device 120.

Accordingly, the format conversion manager 170 may convert data records 155 to a format compatible with the input to the particular data processing or machine learning model. Similarly, the format conversion manager 170 may convert the output of a data processing or machine learning model (e.g., from the data processing/machine learning manager 175) to a data record format compatible with a database 150 in which data records 155 that include the output are stored. Similarly, if the output of the data processing or machine learning model is provided directly to a computing device 120 (e.g., to an administrative user associated with the computing device 120), the format conversion manager 170 may convert the output of a data processing or machine learning model (e.g., from the data processing/machine learning manager 175) to an information format compatible with the particular API (e.g., based on the API manager 180) used to provide the information from the data security system 110 to the computing device 120.

Similarly, the format of data records 155 stored in a particular database 150 may be different than a format compatible with an API used to provide information to the computing device 120. For example, an administrative user associated with the computing device 120 may request, via a UI of the computing device 120, a particular set of information. The data security system controller 125 may receive the request (e.g., via the UI manager 145), and may query the data records 155 in the databases 150 based on the request. For example, the request may indicate data records 155 associated with a particular user account or set of user accounts during a particular time range. As another example, the request may indicate data records 155 associated with a particular computing asset or set of computing assets during a particular time range. As another example, the request may indicate data records 155 associated with a particular type of malware or CVE during a particular time range. As another example, the request may indicate data records 155 associated with a particular type of event (e.g., a scan event) during a particular time range. The data security system controller 125 may retrieve the data records 155 that match the request, and the format conversion manager 170 may convert the retrieved data records 155 from the storage format associated with the corresponding database(s) 150 to a format compatible with the particular API (e.g., based on the API manager 180) used to provide the information from the data security system 110 to the computing device 120.

Accordingly, as described herein, the data security system 110 may flexibly store data obtained in data files of multiple formats from multiple data information sources 160 in one or more databases 150 associated with different storage formats. The data security system 110 may similarly flexibly perform data processing on data stored in one or more databases 150 and may store the output of the data processing in one or more databases 150. The data stored in the one or more databases 150 may be flexibly retrieved and displayed at a user device (e.g., a computing device 120) via one or more APIs (e.g., as controlled by the API manager 180).

It should be appreciated by a person skilled in the art that one or more aspects of the disclosure may be implemented in a computing environment 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

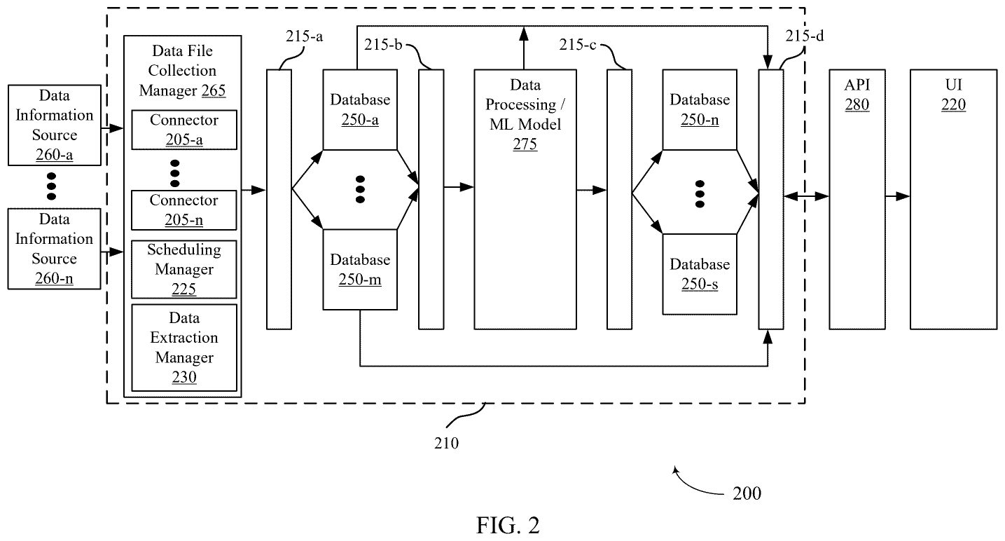

FIG. 2 shows an example of a security data pipeline 200 that supports security data ingestion and processing in accordance with aspects of the present disclosure. The security data pipeline 200 may implement or may be implemented by aspects of the computing environment 100. For example, the security data pipeline 200 may include a data security system 210, which may be an example of a data security system 110 as described herein.

The data security system 110 may include a data file collection manager 265, which may be an example of a data file collection manager 165 as described herein. For example, the data file collection manager 265 may obtain data files from multiple data information sources 260. The data file collection manager 265 may map raw data input via the data files to defined input data schemas/structures and data storage (e.g., databases 250 and corresponding data formats).

For example, the data file collection manager 265 may include a connector 205 for each respective data information source 260 which may establish a connection (e.g., an IP connection) with the respective data information source 260 to receive data files from the respective data information source 260. The connectors 205 may obtain raw data from data information sources based on input layer definitions. For example, a data connector 205-a may connect with the data information source 260-a, and a data connector 205-n may connect with the data information source 260-n. The data file collection manager 265 may include a data extraction manager 230 which may extract information from data files obtained by the data file collection manager 265 from the data information sources 260. For example, the data extraction manager 230 may extract particular fields from received data files which may be relevant for data security purposes. For example, extracted fields may include the computing asset identifier (e.g., hostname, fully qualified domain name, medium access control (MAC) address, internet protocol (IP) address, or serial number), identifiers for associated user accounts, and event-type information (e.g., error strings, scan log information, access log information, malware or CVE type information, or the like). Extraction of relevant information from the data files (e.g., the relevant fields) may allow the data security system 210 to reduce the amount of data stored in the databases 250 and/or to more efficiently search for particular information (e.g., based on fields and based on a reduced total amount of data to search in the databases 250). The scheduling manager 225 may manage the scheduling of storage of information received and/or extracted by the data file collection manager 265 from data files into one or more databases 150. The databases 250 of the security data pipeline 200 may be examples of databases 150 as described herein.

As described herein, databases 250 may store information as data records in a format associated with the particular databases 250. An abstraction layer 215-a may convert information extracted from data files by the data extraction manager 230 into data records in a format associated with a particular database 250. For example, the abstraction layer 215-a may be implemented by the format conversion manager 170 of FIG. 1. For example, the database 250-a may use a first data record format, and the database 250-m may use a second data record format. Information scheduled, by the scheduling manager 225, for storage in the database 250-a may be converted to the first format via the abstraction layer 215-a. Similarly, information scheduled, by the scheduling manager 225, for storage in the database 250-a may be converted to the first format via the abstraction layer 215-a. Information stored in the database 250-a and the database 250-m may be raw data (e.g., data extracted from the data files received by the data file collection manager 265 may not be processed via a data processing or machine learning model or algorithm).

In some examples, the data security system 110 may receive, via an API 280 and from a UI 220, a request for raw data (e.g., data from a database 250-a or a database 250-m that has not been processed via a data processing or machine learning model or algorithm). For example, the UI 220 may be an example of a UI at a computing device 120 as described herein. As another example, the UI 220 maybe an example of a web console or a cloud micro-service. The UI 220 may be any interface or user endpoint which may display data to a user. The API 280 may provide information to the UI 220 in a format associated with the API 280. The data security system 110 may retrieve the raw data from the database 250-a or the database 250-m and may convert the raw data from the storage format associated with the database 250-a or the database 250-m to the format associated with the API 280 using an abstraction layer 215-d. For example, the abstraction layer 215-d may be implemented by the format conversion manager 170 of FIG. 1. The API 280 may provide the converted data to the UI 220, which may display the data to a user of the UI 220. The API 280 and the abstraction layer 215-d may function as an output layer of the data security system 210 which may map raw or processed data to a format consumable by the UI 220 (e.g., JSON strings).

In some examples, the data security system 210 may provide data processing or machine learning processing on raw data stored in the database 250-a or the database 250. For example, data processing or machine learning processing on raw data may be performed for the extraction of relevant data, classification of data, identification of patterns or anomalies in the collected information, summary of data, or prediction of future threats or events based on the raw data. The data security system 210 may perform data processing or machine learning processing via providing data as an input to a data processing or machine learning model 275. Different data processing or machine learning models 275 may have different data input formats, which may be different than the data record formats of the databases 250. Accordingly, data which is retrieved from one or more databases 250 for input to a data processing or machine learning model 275 may be converted to the data input format for the data processing or machine learning model 275 via an abstraction layer 215-b. For example, the abstraction layer 215-b may be implemented by the format conversion manager 170 of FIG. 1.

In some examples, the data security system 210 may provide the output of the data processing or machine learning model 275 to the UI 220. For example, the data security system 210 may receive, via an API 280 and from the UI 220, a request for processed data.

For example, a user of the UI 220 may input the request the UI 220. For example, the request may indicate requested pattern or anomaly detection, classification of data, summary of data, or prediction of threats or events. In some examples, the data security system 210 may be configured with, may have access to, or may otherwise use multiple data processing or machine learning models 275. As described herein, each data processing or machine learning model 275 may have an associated data input format and data output format. The abstraction layer 215-b may convert raw data retrieved from the database 250-a or the database 250-m in response to the request to the data input format associated with the particular data processing or machine learning model 275 identified in association with the request. The abstraction layer 215-d may convert the output of the data processing or machine learning model 275 to the format associated with the API 280. The API 280 may provide the converted data to the UI 220, which may display the data to a user of the UI 220.

In some examples, the output of the data processing or machine learning model 275 may be stored in one or more databases 250 (e.g., different databases 250-n or 250-s, or the same databases 250-a or 250-m as the raw data). The output of the data processing or machine learning model 275 have a different format than the one or more databases 250 in which the output is stored. Accordingly, the data security system 210 may convert the output to the format(s) of the data records for the one or more databases 250 in which the output is stored using an abstraction layer 215-c. For example, the abstraction layer 215-c may be implemented by the format conversion manager 170 of FIG. 1.

In some examples, the data security system 210 may receive, via an API 280 and from a UI 220, a request for processed data (e.g., data from a database 250-n or the database 250-s that has been processed via a data processing or machine learning model 275). For example, the request may indicate requested pattern or anomaly detection, classification of data, summary of data, or prediction of threats or events. The data security system 110 may query the database(s) 250 for the requested processed information. The API 280 may provide information to the UI 220 in a format associated with the API 280. The data security system 110 may retrieve the processed data from the databases 250 and may convert the processed data from the storage format(s) associated with the database(s) 250 to the format associated with the API 280 using the abstraction layer 215-d. The API 280 may provide the converted data to the UI 220, which may display the data to a user of the UI 220.

In some examples, the data security system 210 may receive, via an API 280 and from a UI 220, a request for both processed data and raw data. For example, the request may indicate requested pattern or anomaly detection, classification of data, a summary of data, or prediction of threats or events, and may also indicate a request for the corresponding raw data used to generate the processed data. The data security system 210 may query the database(s) 250 for the requested processed information and raw data. The API 280 may provide information to the UI 220 in a format associated with the API 280. The data security system 210 may retrieve the processed data and the corresponding raw data from the databases 250 and may convert the processed data and the raw data from the storage format(s) associated with the database(s) 250 to the format associated with the API 280 using the abstraction layer 215-d. The API 280 may provide the converted data to the UI 220, which may display the data to a user of the UI 220.

Accordingly, as described herein, the data security system 210 may obtain data files (e.g., via the data file collection manager 265) from multiple data information sources 260. The data security system 210 may use one of the multiple abstraction layers 215 to transform raw data from data files into a format compatible with a target data store (e.g., a database 250-a or a database 250-m). The data security system 210 may store the transformed raw data in the target data store. For example, the raw data may be JSON data and may be transformed into SQL statements and executed on a SQL database (e.g., a database 250 may be a SQL database). In some examples, the data security system 210 may use one of the abstraction layers 215 to transform raw data stored in database(s) 250 into a structure suitable for data processing or machine learning processing (e.g., the data returned from a SQL database may be converted into python dictionaries or JSON, which may be provided as input to a data processing or machine learning model 275). The data security system 210 may use an abstraction layer 215 to transform the output of a data processing or machine learning model 275 into a format for storage in a database 250 (e.g., a downstream database 250-n or a downstream database 250-s). For example, the output of the data processing or machine learning model 275 may be a python dictionary or JSON, and the abstraction layer 215 may convert the python dictionary or JSON to a NoSQL document which may be inserted into an instance of a NoSQL database. The API 280 may use an abstraction layer 215 to transform structured data in the databases 250 (e.g., raw data or processed data) into a format consumable by a UI at the UI 220 (e.g., documents retrieved from a NoSQL database or SQL statements retrieved from a SQL database may be transformed into JSON strings and returned by the API 280).

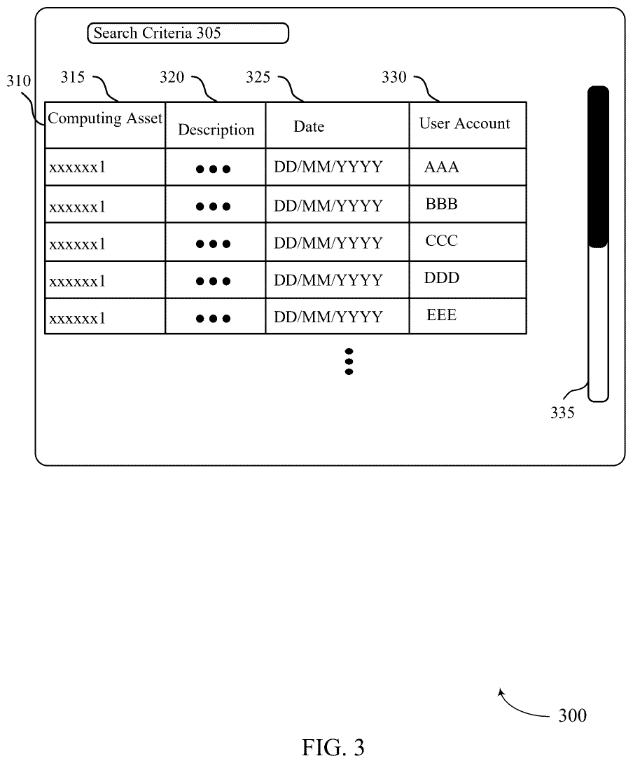

FIG. 3 shows an example of a UI view 300 that supports security data ingestion and processing in accordance with aspects of the present disclosure. The UI view 300 may implement or may be implemented by aspects of the computing environment 100 or the security data pipeline 200. For example, the UI view 300 may be presented on a display of a computing device 120 or a UI 220 as described herein.

The UI view 300 shows a view of a result of a query for a particular computing asset. As described herein, a user of a computing device in communication with the data security system 110 or the data security system 210 via an API may submit a query for information collected and stored by the data security system 110 or the data security system 210 in one or more databases 150 or 250. For example, the user may input search criteria into a search criteria field 305. For example, the user may specify one or more computing assets (e.g., by computing asset ID such as by hostname, fully qualified domain name, MAC address, IP address, or serial number), a group of computing assets (e.g., by group identifier or location), a date range, one or more user accounts (e.g., by user identifier such as organization user identifier or email address), a group of user accounts (e.g., by group identifier such as engineering, human resources, information technology), and/or any other field such as type of data record (e.g., error log, scan log, malware blocking log, malware removal log, access account log, scan summary record, error summary record, CVE information record, malware information record, or the like) via the search criteria field 305. For example, once a user submits a query via the search criteria field 305, the API may submit the query to the data security system 110 or the data security system 210. The data security system 110 or the data security system 210 may search the databases 150 or the databases 250 for data records that match the query received via the API. In some examples, the data security system 110 or the data security system 210 may perform data processing based on the query, as described herein. For example, the data records may be examples of data records 155 as described herein.

The data security system 110 or the data security system 210 may retrieve the data records that match the query from the databases 150 or the databases 250, may convert the data records from the storage format(s) in the databases 150 or the databases 250 to a format compatible with the API, and may provide the information from the data records to the UI view 300 via the API. For example, the UI view 300 may display a table 310 of data records that match the search criteria submitted in the search criteria field 305 and were provided via the API. For example, the table 310 may include a computing asset column 315, a description column 320, a date column 325, and a user account column 330. The computing asset column 315 may indicate the corresponding computing asset for the data record (e.g., the computing asset 105 for which the data record was generated or describes). The description column 320 may include information contained in the data record (e.g., information regarding the action or event that caused generation of the data record). The date column 325 may indicate a date and/or time that the data record 155 was generated or received by the data security system 110 or the data security system 210. The user account column 330 may indicate the user account (if applicable) associated with the data record (e.g., the user account associated with the corresponding computing asset or whose action caused the generation of the data record). The UI view 300 may include a scroll bar 335 to scroll through the data records included in the table 310.

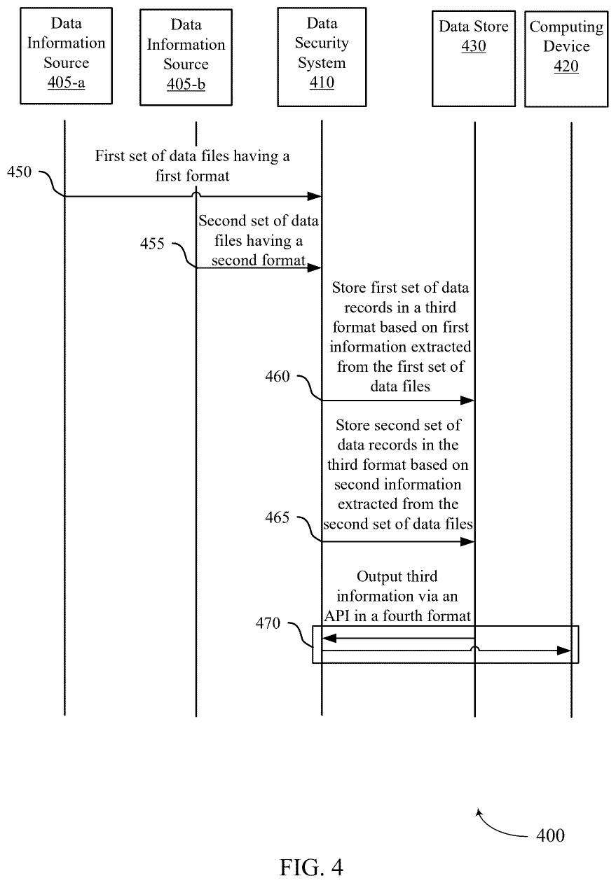

FIG. 4 shows an example of a process flow 400 that supports security data ingestion and processing in accordance with aspects of the present disclosure. The process flow 400 may implement or may be implemented by one or more aspects of the computing environment 100, the security data pipeline 200, or the UI view 300. For example, the process flow 400 may include a data security system 410, which may be an example of a data security system 110 or a data security system 210 as described herein. The process flow 400 may include a first data store 430, which may be an example of a database 150 or a database 250 as described herein. For example, the first data store 430 may be accessible to the data security system 410. The process flow 400 may include a first data information source 405-a and a second data information source 405-b, which may be examples of data information sources 160 as described herein. The process flow 400 may include a computing device 420, which may be an example of a computing device 120 or a UI 220 as described herein. For example, the computing device 420 may be any user endpoint which may display data to a user and/or may receive input from a user (e.g., may receive requests for data from the user). In the following description of the process flow 400, operations between the data security system 410, the computing device 420, the first data store 430, the first data information source 405-a, and the second data information source 405-b may be added, omitted, or performed in a different order (with respect to the exemplary order shown).

At 450, the data security system 410 may obtain a first set of data files from the first data information source 405-a (e.g., a first security data source). The first set of data files may have a first format. For example, the first format may be in a format associated with JSON.

At 455, the data security system 410 may obtain a second set of data files from the second data information source 405-b. The second set of data files may have a second format. For example, the first format may be in a format associated with JavaScript.

At 460, the data security system 410 may store, at the first data store 430, a first set of data records that include first information extracted from the first set of data files. The first set of data records may be stored in a third format associated with the first data store 430. For example, the first information may be extracted from the first set of data files via a data extraction manager 230 as described herein.

At 465, the data security system 410 may store, at the first data store 430, a second set of data records that include second information extracted from the second set of data files. The second set of data records may be stored in the third format associated with the first data store 430. For example, the second information may be extracted from the second set of data files via a data extraction manager 230 as described herein.

At 470, the data security system 410 may output, to the computing device 420 via an API, third information in a fourth format associated with the API. The third information may be based on the second information and the third information. For example, the third information may be retrieved from the first data store 430 by the data security system 410 for output to the computing device 420.

In some examples, the data security system 410 may obtain, from the computing device 420 and via the API, a request for the third information in the fourth format. In such examples, outputting the third information may be based on the request.

In some examples, the data security system 410 may output, to the computing device 420 or a second computing device via a second API, fourth information in a fifth format associated with the second API. The fourth information may include at least a second portion of the second information and the third information. For example, the data security system 410 may use different APIs to provide information from the first data store 430 to computing devices, and the different APIs may be based on, for example, the types of computing devices, the type of request, or the type of application running at the computing device.

In some examples, the data security system 410 may apply a machine learning model or data processing (e.g., a data processing or machine learning model 275) to fourth information to generate a third set of data records. The fourth information may be based on (e.g., retrieved from or may include) the first information and the second information. The third information provided to the computing device 420 at 470 may be based on the third set of data records. For example, the third information output at 470 may include data processed by the machine learning model or data processing. In some examples, the data security system 410 may store, in a second data store accessible to the data security system 410, the third set of data records in fifth format associated with the second data store. In such examples, the data security system 410 may obtain at least some of the third information output at 470 from the second data store. In some such examples, the data security system 410 may convert the generated third set of data records from a sixth format associated with the machine learning model or data processing to the fifth format. For example, the data security system 410 may convert the output of the machine learning model or data processing to a format compatible with the second data store. In some examples, the third information output at 470 may include a first subset of information retrieved from the first data store (e.g., raw data) and a second subset of information retrieved from the second data store (e.g., processed data). In some examples, the data security system 410 may convert at least a first portion of the first set of data records to a fifth format associated with the machine learning model or data processing, and the data security system 410 may convert at least a second portion of the second set of data records to the fifth format, where the fourth information includes the converted at least the first portion and the converted at least the second portion. For example, the data security system 410 may perform data processing on data from the first set of data records and the second set of data records. In some examples, the data security system 410 may obtain, from the computing device 420 and via the API, a request for the third information in the fourth format (e.g., for processed data). The data security system 410 may apply the machine learning model or data processing based on the request. In some examples, the fourth information may be based on a fourth set of data records stored in a second data store accessible to the data security system 410, the fourth set of data records stored in a fifth format associated with the second data store. In such examples, the data security system 410 may convert a portion of the fourth information based on the second information and the third information from the third format to a sixth format associated with the machine learning model or data processing, and the data security system 410 may convert the fourth set of data records from the fifth format to the sixth format. In some such examples, the data security system 410 may store, at the second data store, the fourth set of data records in the fourth format that includes information extracted from the first set of data files. For example, data extracted from the first set of data files may be stored at multiple data stores.

In some examples, the third information may include one or more first data records of the first set of data records and one or more second data records of the second set of data records. For example, the data security system 410 may provide raw data to the computing device 420 via the API.

In some examples, the first information may include a subset of a cumulative amount of information of the first set of data files, and the second information may include a subset of a cumulative amount of information of the second set of data files. For example, the data security system 410 may extract relevant information for storage at the first data store 430 from the sets of data files obtained from data information sources as described herein.

In some examples, the data security system 410 may perform deduplication of information in obtained data files. For example, the data security system 410 may identify duplicate information in the first set of data files and the second set of data files, and the first information and the second information may collectively include a single copy of the duplicate information.

In some examples, the data security system 410 may receive third set of data files from a third security data source, the third set of data files having a fifth format. The data security system 410 may store, at the first data store 430, a third set of data records comprising information extracted from the third set of data files, the third set of data records stored in the third format. For example, the data security system 410 may obtain data files from any quantity of security data sources (e.g., data information sources).

In some examples, the data security system 410 may cause, via the API, display of the third information at a UI of the computing device 420. The computing device 420 may be associated with a client account of the data security system 410.

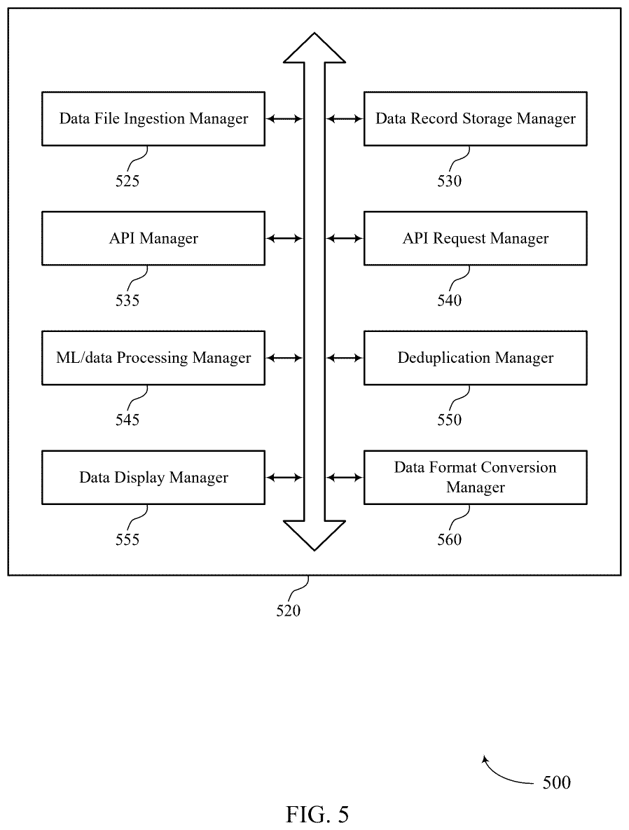

FIG. 5 shows a block diagram 500 of a data security system 520 that supports security data ingestion and processing in accordance with aspects of the present disclosure. The data security system 520 may be an example of aspects of a data security system as described with reference to FIGS. 1 through 4. The data security system 520, or various components thereof, may be an example of means for performing various aspects of security data ingestion and processing as described herein. For example, the data security system 520 may include a data file ingestion manager 525, a data record storage manager 530, an API manager 535, an API request manager 540, a ML/data processing manager 545, a deduplication manager 550, a data display manager 555, a data format conversion manager 560, or any combination thereof. Each of these components, or components of subcomponents thereof (e.g., one or more processors, one or more memories), may communicate, directly or indirectly, with one another (e.g., via one or more buses). In some examples, one or more components of the data security system 520 may be implemented across one or more distributed servers or as cloud applications and may communicate with each other over network connections (e.g., via communication links 115 as described herein).

The data file ingestion manager 525 may be configured to support obtaining, at a data security system, a first set of data files from a first security data source, the first set of data files having a first format. In some examples, the data file ingestion manager 525 may be configured to support obtaining, at the data security system, a second set of data files from a second security data source, the second set of data files having a second format different from the first format. The data record storage manager 530 may be configured to support storing, by the data security system and at a first data store accessible to the data security system, a first set of data records including first information extracted from the first set of data files, the first set of data records stored in a third format associated with the first data store. In some examples, the data record storage manager 530 may be configured to support storing, by the data security system and at the first data store, a second set of data records including second information extracted from the second set of data files, the second set of data records stored in the third format. The API manager 535 may be configured to support outputting by the data security system to a computing device via an API, third information in a fourth format associated with the API, the third information based on the second information and the third information.

In some examples, the API request manager 540 may be configured to support obtaining, by the data security system from the computing device and via the API, a request for the third information in the fourth format, where outputting the third information is based on the request.

In some examples, the API manager 535 may be configured to support outputting, by the data security system to the computing device or a second computing device via a second API, fourth information in a fifth format associated with the second API, the fourth information including at least a second portion of the second information and the third information.

In some examples, the ML/data processing manager 545 may be configured to support applying, by the data security system, a machine learning model or data processing to fourth information to generate a third set of data records, the fourth information based on the first information and the second information, and where the third information is based on the third set of data records.

In some examples, the data record storage manager 530 may be configured to support storing, by the data security system and in a second data store accessible to the data security system, the third set of data records in fifth format associated with the second data store. In some examples, the data record storage manager 530 may be configured to support obtaining, at least in part, the third information from the second data store.

In some examples, the data format conversion manager 560 may be configured to support converting, by the data security system, the generated third set of data records from a sixth format associated with the machine learning model or data processing to the fifth format.

In some examples, the third information includes a first subset of information retrieved from the first data store and a second subset of information retrieved from the second data store.

In some examples, the data format conversion manager 560 may be configured to support converting, by the data security system, at least a first portion of the first set of data records to a fifth format associated with the machine learning model or data processing. In some examples, the data format conversion manager 560 may be configured to support converting, by the data security system, at least a second portion of the second set of data records to the fifth format, where the fourth information includes the converted at least the first portion and the converted at least the second portion.

In some examples, the API request manager 540 may be configured to support obtaining, by the data security system from the computing device via the API, a request for the third information in the fourth format, where application of the machine learning model or data processing is based on the request.

In some examples, the fourth information is further based on a fourth set of data records stored in a second data store accessible to the data security system, and the data format conversion manager 560 may be configured to support converting a portion of the fourth information based on the second information and the third information from the third format to a sixth format associated with the machine learning model or data processing. In some examples, the fourth information is further based on a fourth set of data records stored in a second data store accessible to the data security system, and the data format conversion manager 560 may be configured to support converting the fourth set of data records from the fifth format to the sixth format.

In some examples, the data record storage manager 530 may be configured to support storing by the data security system and at the second data store, the fourth set of data records in the fourth format including information extracted from the first set of data files.

In some examples, the third information includes one or more first data records of the first set of data records and one or more second data records of the second set of data records.

In some examples, the first information includes a subset of a cumulative amount of information of the first set of data files. In some examples, the second information includes a subset of a cumulative amount of information of the second set of data files.

In some examples, the deduplication manager 550 may be configured to support identifying duplicate information in the first set of data files and the second set of data files, where the first information and the second information includes a single copy of the duplicate information.

In some examples, the data file ingestion manager 525 may be configured to support receiving, at the data security system, a third set of data files from a third security data source, the third set of data files having a fifth format. In some examples, the data record storage manager 530 may be configured to support storing, by the data security system and at the first data store, a third set of data records including information extracted from the third set of data files, the third set of data records stored in the third format.

In some examples, the data display manager 555 may be configured to support causing, by the data security system and via the API, display of the third information at a user interface of the computing device, where the computing device is associated with a client account of the data security system.

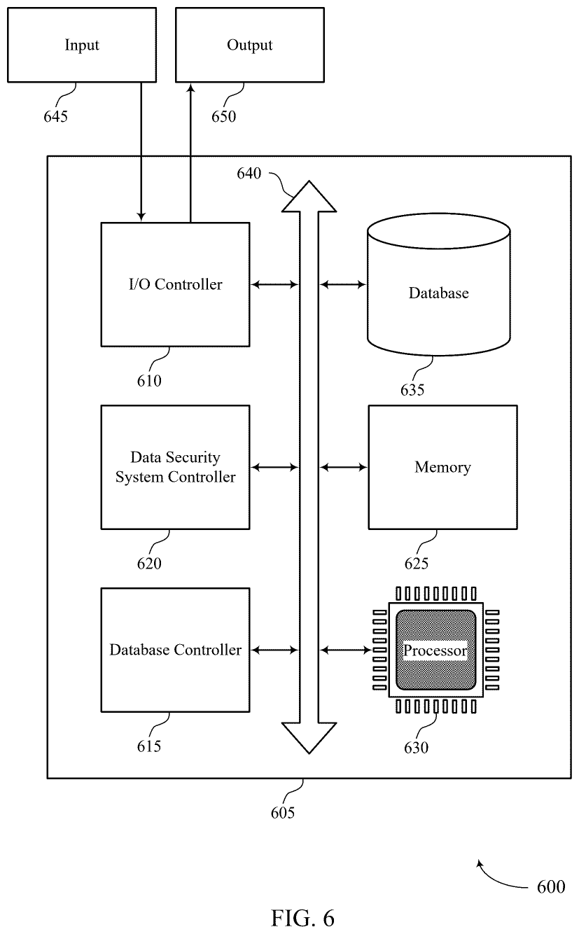

FIG. 6 shows a diagram of a system 600 including a device 605 that supports security data ingestion and processing in accordance with aspects of the present disclosure.

The device 605 may include components for bi-directional data communications including components for transmitting and receiving communications, such as a data security system controller 620, an input/output (I/O) controller, such as an I/O controller 610, a database controller 615, at least one memory 625, at least one processor 630, and a database 635.

These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting security data ingestion and processing). The processor 630 may be an example of a single processor or multiple processors. For example, the device 605 may include one or more processors 630.

For example, the data security system controller 620 may be configured to support obtaining, at a data security system, a first set of data files from a first security data source, the first set of data files having a first format. The data security system controller 620 may be configured to support obtaining, at the data security system, a second set of data files from a second security data source, the second set of data files having a second format different from the first format. The data security system controller 620 may be configured to support storing, by the data security system and at a first data store accessible to the data security system, a first set of data records including first information extracted from the first set of data files, the first set of data records stored in a third format associated with the first data store. The data security system controller 620 may be configured to support storing, by the data security system and at the first data store, a second set of data records including second information extracted from the second set of data files, the second set of data records stored in the third format. The data security system controller 620 may be configured to support outputting by the data security system to a computing device via an API, third information in a fourth format associated with the API, the third information based on the second information and the third information.

By including or configuring the data security system controller 620 in accordance with examples as described herein, the device 605 may support techniques for more efficient data storage, reduced latency with regard to data queries, and reduced amount of data stored, and more efficient and relevant responses to data queries.

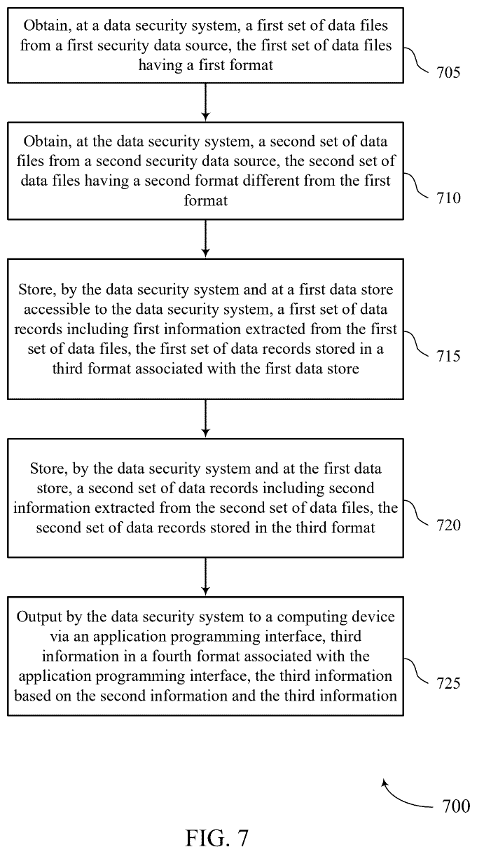

FIG. 7 shows a flowchart illustrating a method 700 that supports security data ingestion and processing in accordance with aspects of the present disclosure. The operations of the method 700 may be implemented by a data security system or its components as described herein. For example, the operations of the method 700 may be performed by a data security system as described with reference to FIGS. 1 through 6. In some examples, a data security system may execute a set of instructions to control the functional elements of the data security system to perform the described functions. Additionally, or alternatively, the data security system may perform aspects of the described functions using special-purpose hardware.

At 705, the method may include obtaining, at a data security system, a first set of data files from a first security data source, the first set of data files having a first format. The operations of 705 may be performed in accordance with examples as disclosed herein. In some examples, aspects of the operations of 705 may be performed by a data file ingestion manager 525 as described with reference to FIG. 5.

At 710, the method may include obtaining, at the data security system, a second set of data files from a second security data source, the second set of data files having a second format different from the first format. The operations of 710 may be performed in accordance with examples as disclosed herein. In some examples, aspects of the operations of 710 may be performed by a data file ingestion manager 525 as described with reference to FIG. 5.

At 715, the method may include storing, by the data security system and at a first data store accessible to the data security system, a first set of data records including first information extracted from the first set of data files, the first set of data records stored in a third format associated with the first data store. The operations of 715 may be performed in accordance with examples as disclosed herein. In some examples, aspects of the operations of 715 may be performed by a data record storage manager 530 as described with reference to FIG. 5.

At 720, the method may include storing, by the data security system and at the first data store, a second set of data records including second information extracted from the second set of data files, the second set of data records stored in the third format. The operations of 720 may be performed in accordance with examples as disclosed herein. In some examples, aspects of the operations of 720 may be performed by a data record storage manager 530 as described with reference to FIG. 5.

At 725, the method may include outputting by the data security system to a computing device via an API, third information in a fourth format associated with the API, the third information based on the second information and the third information. The operations of 725 may be performed in accordance with examples as disclosed herein. In some examples, aspects of the operations of 725 may be performed by an API manager 535 as described with reference to FIG. 5.

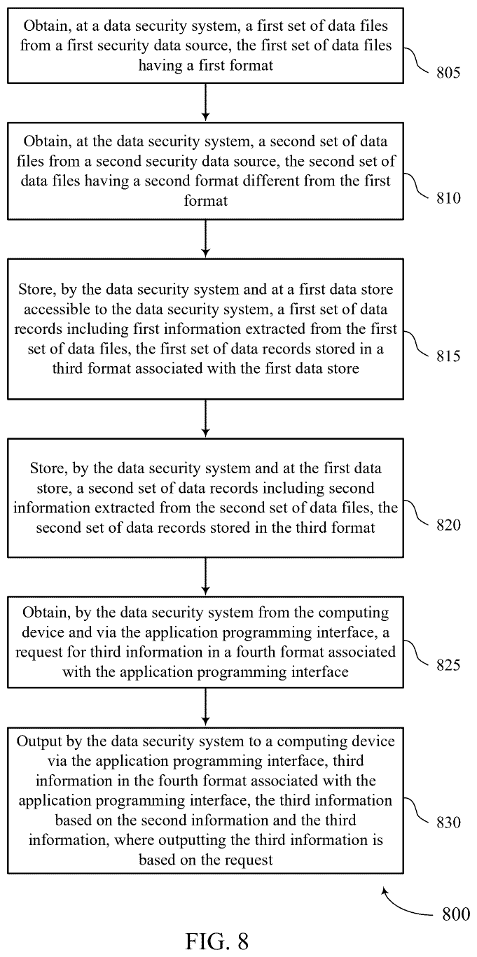

FIG. 8 shows a flowchart illustrating a method 800 that supports security data ingestion and processing in accordance with aspects of the present disclosure. The operations of the method 800 may be implemented by a data security system or its components as described herein. For example, the operations of the method 800 may be performed by a data security system as described with reference to FIGS. 1 through 6. In some examples, a data security system may execute a set of instructions to control the functional elements of the data security system to perform the described functions. Additionally, or alternatively, the data security system may perform aspects of the described functions using special-purpose hardware.

At 805, the method may include obtaining, at a data security system, a first set of data files from a first security data source, the first set of data files having a first format. The operations of 805 may be performed in accordance with examples as disclosed herein. In some examples, aspects of the operations of 805 may be performed by a data file ingestion manager 525 as described with reference to FIG. 5.

At 810, the method may include obtaining, at the data security system, a second set of data files from a second security data source, the second set of data files having a second format different from the first format. The operations of 810 may be performed in accordance with examples as disclosed herein. In some examples, aspects of the operations of 810 may be performed by a data file ingestion manager 525 as described with reference to FIG. 5.

At 815, the method may include storing, by the data security system and at a first data store accessible to the data security system, a first set of data records including first information extracted from the first set of data files, the first set of data records stored in a third format associated with the first data store. The operations of 815 may be performed in accordance with examples as disclosed herein. In some examples, aspects of the operations of 815 may be performed by a data record storage manager 530 as described with reference to FIG. 5.

At 820, the method may include storing, by the data security system and at the first data store, a second set of data records including second information extracted from the second set of data files, the second set of data records stored in the third format. The operations of 820 may be performed in accordance with examples as disclosed herein. In some examples, aspects of the operations of 820 may be performed by a data record storage manager 530 as described with reference to FIG. 5.

At 825, the method may include obtaining, by the data security system from the computing device and via an API, a request for the third information in a fourth format associated with the API. The operations of 825 may be performed in accordance with examples as disclosed herein. In some examples, aspects of the operations of 825 may be performed by an API request manager 540 as described with reference to FIG. 5.

At 830, the method may include outputting by the data security system to a computing device via the API, third information in the fourth format associated with the API, the third information based on the second information and the third information, and where outputting the third information is based on the request. The operations of 830 may be performed in accordance with examples as disclosed herein. In some examples, aspects of the operations of 830 may be performed by an API manager 535 as described with reference to FIG. 5.

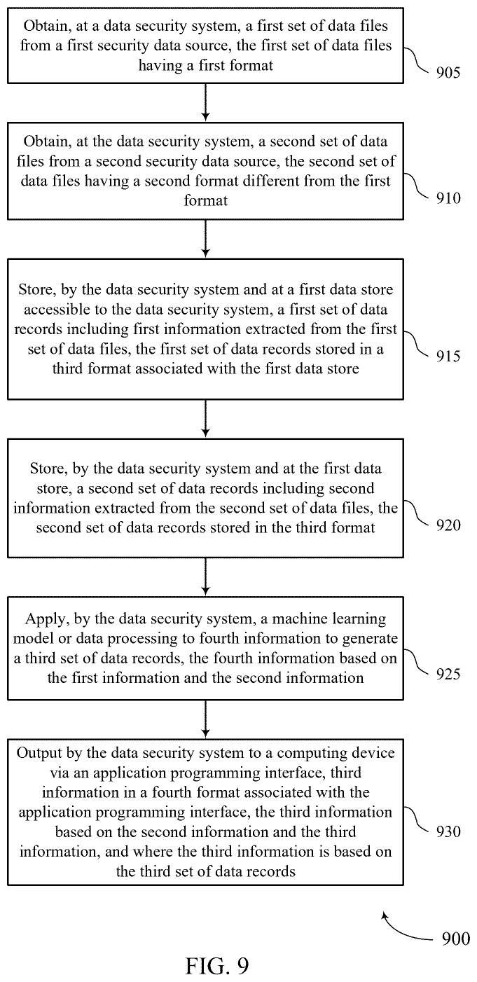

FIG. 9 shows a flowchart illustrating a method 900 that supports security data ingestion and processing in accordance with aspects of the present disclosure. The operations of the method 900 may be implemented by a data security system or its components as described herein. For example, the operations of the method 900 may be performed by a data security system as described with reference to FIGS. 1 through 6. In some examples, a data security system may execute a set of instructions to control the functional elements of the data security system to perform the described functions. Additionally, or alternatively, the data security system may perform aspects of the described functions using special-purpose hardware.

At 905, the method may include obtaining, at a data security system, a first set of data files from a first security data source, the first set of data files having a first format. The operations of 905 may be performed in accordance with examples as disclosed herein. In some examples, aspects of the operations of 905 may be performed by a data file ingestion manager 525 as described with reference to FIG. 5.

At 910, the method may include obtaining, at the data security system, a second set of data files from a second security data source, the second set of data files having a second format different from the first format. The operations of 910 may be performed in accordance with examples as disclosed herein. In some examples, aspects of the operations of 910 may be performed by a data file ingestion manager 525 as described with reference to FIG. 5.

At 915, the method may include storing, by the data security system and at a first data store accessible to the data security system, a first set of data records including first information extracted from the first set of data files, the first set of data records stored in a third format associated with the first data store. The operations of 915 may be performed in accordance with examples as disclosed herein. In some examples, aspects of the operations of 915 may be performed by a data record storage manager 530 as described with reference to FIG. 5.

At 920, the method may include storing, by the data security system and at the first data store, a second set of data records including second information extracted from the second set of data files, the second set of data records stored in the third format. The operations of 920 may be performed in accordance with examples as disclosed herein. In some examples, aspects of the operations of 920 may be performed by a data record storage manager 530 as described with reference to FIG. 5.

At 925, the method may include applying, by the data security system, a machine learning model or data processing to fourth information to generate a third set of data records, the fourth information based on the first information and the second information, and where the third information is based on the third set of data records. The operations of 925 may be performed in accordance with examples as disclosed herein. In some examples, aspects of the operations of 925 may be performed by a ML/data processing manager 545 as described with reference to FIG. 5.

At 930, the method may include outputting by the data security system to a computing device via an API, third information in a fourth format associated with the API, the third information based on the second information and the third information, and where the third information is based on the third set of data records. The operations of 930 may be performed in accordance with examples as disclosed herein. In some examples, aspects of the operations of 930 may be performed by an API manager 535 as described with reference to FIG. 5.

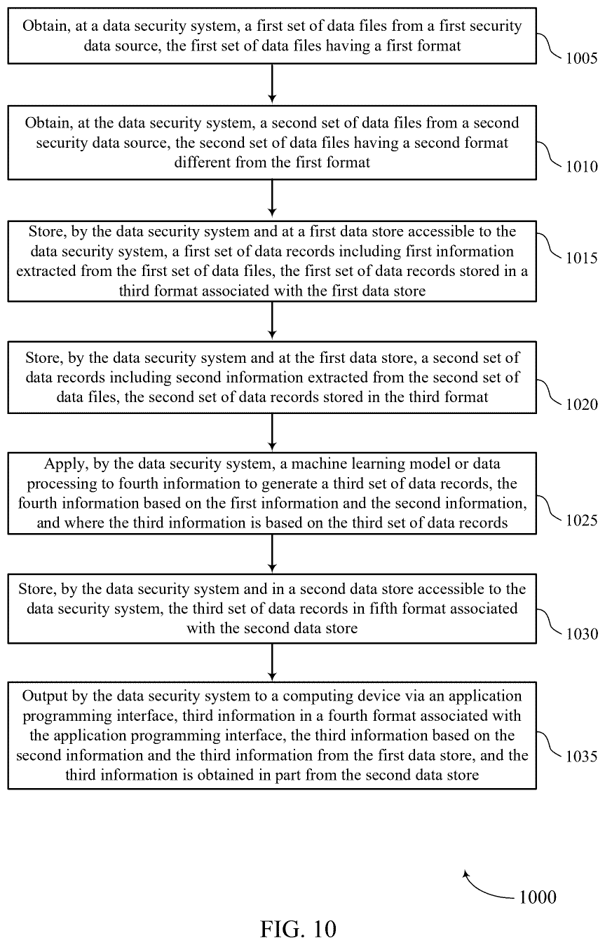

FIG. 10 shows a flowchart illustrating a method 1000 that supports security data ingestion and processing in accordance with aspects of the present disclosure. The operations of the method 1000 may be implemented by a data security system or its components as described herein. For example, the operations of the method 1000 may be performed by a data security system as described with reference to FIGS. 1 through 6. In some examples, a data security system may execute a set of instructions to control the functional elements of the data security system to perform the described functions. Additionally, or alternatively, the data security system may perform aspects of the described functions using special-purpose hardware.

At 1005, the method may include obtaining, at a data security system, a first set of data files from a first security data source, the first set of data files having a first format. The operations of 1005 may be performed in accordance with examples as disclosed herein. In some examples, aspects of the operations of 1005 may be performed by a data file ingestion manager 525 as described with reference to FIG. 5.

At 1010, the method may include obtaining, at the data security system, a second set of data files from a second security data source, the second set of data files having a second format different from the first format. The operations of 1010 may be performed in accordance with examples as disclosed herein. In some examples, aspects of the operations of 1010 may be performed by a data file ingestion manager 525 as described with reference to FIG. 5.

At 1015, the method may include storing, by the data security system and at a first data store accessible to the data security system, a first set of data records including first information extracted from the first set of data files, the first set of data records stored in a third format associated with the first data store. The operations of 1015 may be performed in accordance with examples as disclosed herein. In some examples, aspects of the operations of 1015 may be performed by a data record storage manager 530 as described with reference to FIG. 5.

At 1020, the method may include storing, by the data security system and at the first data store, a second set of data records including second information extracted from the second set of data files, the second set of data records stored in the third format. The operations of 1020 may be performed in accordance with examples as disclosed herein. In some examples, aspects of the operations of 1020 may be performed by a data record storage manager 530 as described with reference to FIG. 5.

At 1025, the method may include applying, by the data security system, a machine learning model or data processing to fourth information to generate a third set of data records, the fourth information based on the first information and the second information. The operations of 1025 may be performed in accordance with examples as disclosed herein. In some examples, aspects of the operations of 1025 may be performed by a ML/data processing manager 545 as described with reference to FIG. 5.

At 1030, the method may include storing, by the data security system and in a second data store accessible to the data security system, the third set of data records in fifth format associated with the second data store. The operations of 1030 may be performed in accordance with examples as disclosed herein. In some examples, aspects of the operations of 1030 may be performed by a data record storage manager 530 as described with reference to FIG. 5.

At 1035, the method may include outputting by the data security system to a computing device via an API, third information in a fourth format associated with the API, the third information based on the second information, and the third information from the first data store, and the third information is obtained in part from the second data store. The operations of 1035 may be performed in accordance with examples as disclosed herein. In some examples, aspects of the operations of 1035 may be performed by an API manager 535 as described with reference to FIG. 5.

The following provides an overview of aspects of the present disclosure:
Aspect 1: A method, comprising: obtaining, at a data security system, a first set of data files from a first security data source, the first set of data files having a first format; obtaining, at the data security system, a second set of data files from a second security data source, the second set of data files having a second format different from the first format; storing, by the data security system and at a first data store accessible to the data security system, a first set of data records comprising first information extracted from the first set of data files, the first set of data records stored in a third format associated with the first data store; storing, by the data security system and at the first data store, a second set of data records comprising second information extracted from the second set of data files, the second set of data records stored in the third format; and outputting by the data security system to a computing device via an API, third information in a fourth format associated with the API, the third information based on the second information and the third information.
Aspect 2: The method of aspect 1, further comprising: obtaining, by the data security system from the computing device and via the API, a request for the third information in the fourth format, wherein outputting the third information is based at least in part on the request.
Aspect 3: The method of any of aspects 1 through 2, further comprising: outputting, by the data security system to the computing device or a second computing device via a second API, fourth information in a fifth format associated with the second API, the fourth information comprising at least a second portion of the second information and the third information.
Aspect 4: The method of any of aspects 1 through 3, further comprising: applying, by the data security system, a machine learning model or data processing to fourth information to generate a third set of data records, the fourth information based on the first information and the second information, and wherein the third information is based on the third set of data records.
Aspect 5: The method of aspect 4, further comprising: storing, by the data security system and in a second data store accessible to the data security system, the third set of data records in fifth format associated with the second data store; and obtaining, at least in part, the third information from the second data store.
Aspect 6: The method of aspect 5, further comprising: converting, by the data security system, the generated third set of data records from a sixth format associated with the machine learning model or data processing to the fifth format.
Aspect 7: The method of any of aspects 5 through 6, wherein the third information comprises a first subset of information retrieved from the first data store and a second subset of information retrieved from the second data store.
Aspect 8: The method of any of aspects 4 through 7, further comprising: converting, by the data security system, at least a first portion of the first set of data records to a fifth format associated with the machine learning model or data processing; and converting, by the data security system, at least a second portion of the second set of data records to the fifth format, wherein the fourth information comprises the converted at least the first portion and the converted at least the second portion.
Aspect 9: The method of any of aspects 4 through 8, further comprising: obtaining, by the data security system from the computing device via the API, a request for the third information in the fourth format, wherein application of the machine learning model or data processing is based at least in part on the request.
Aspect 10: The method of any of aspects 4 through 9, wherein the fourth information is further based on a fourth set of data records stored in a second data store accessible to the data security system, the fourth set of data records stored in a fifth format associated with the second data store, the method further comprising: converting a portion of the fourth information based on the second information and the third information from the third format to a sixth format associated with the machine learning model or data processing; and converting the fourth set of data records from the fifth format to the sixth format.
Aspect 11: The method of aspect 10, further comprising: storing by the data security system and at the second data store, the fourth set of data records in the fourth format comprising information extracted from the first set of data files.
Aspect 12: The method of any of aspects 1 through 11, wherein the third information comprises one or more first data records of the first set of data records and one or more second data records of the second set of data records.
Aspect 13: The method of any of aspects 1 through 12, wherein the first information comprises a subset of a cumulative amount of information of the first set of data files, and the second information comprises a subset of a cumulative amount of information of the second set of data files.
Aspect 14: The method of any of aspects 1 through 13, further comprising: identifying duplicate information in the first set of data files and the second set of data files, wherein the first information and the second information comprises a single copy of the duplicate information.
Aspect 15: The method of any of aspects 1 through 14, further comprising: receiving, at the data security system, a third set of data files from a third security data source, the third set of data files having a fifth format; and storing, by the data security system and at the first data store, a third set of data records comprising information extracted from the third set of data files, the third set of data records stored in the third format.
Aspect 16: The method of any of aspects 1 through 15, further comprising: causing, by the data security system and via the API, display of the third information at a user interface of the computing device, wherein the computing device is associated with a client account of the data security system.
Aspect 17: An apparatus comprising one or more memories storing processor-executable code, and one or more processors coupled with the one or more memories and individually or collectively operable to execute the code to cause the apparatus to perform a method of any of aspects 1 through 16.
Aspect 18: An apparatus comprising at least one means for performing a method of any of aspects 1 through 16.
Aspect 19: A non-transitory computer-readable medium storing code the code comprising instructions executable by one or more processors to perform a method of any of aspects 1 through 16.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.
Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
obtaining, at a data security system, a first set of data files from a first security data source, the first set of data files having a first format;
obtaining, at the data security system, a second set of data files from a second security data source, the second set of data files having a second format different from the first format;
storing, by the data security system and at a first data store accessible to the data security system, a first set of data records comprising first information extracted from the first set of data files, the first set of data records stored in a third format associated with the first data store;
storing, by the data security system and at the first data store, a second set of data records comprising second information extracted from the second set of data files, the second set of data records stored in the third format; and
outputting by the data security system to a computing device via an application programming interface, third information in a fourth format associated with the application programming interface, the third information based on the second information and the third information.

2. The method of claim 1, further comprising:
obtaining, by the data security system from the computing device and via the application programming interface, a request for the third information in the fourth format, wherein outputting the third information is based at least in part on the request.

3. The method of claim 1, further comprising:
outputting, by the data security system to the computing device or a second computing device via a second application programming interface, fourth information in a fifth format associated with the second application programming interface, the fourth information comprising at least a second portion of the second information and the third information.

4. The method of claim 1, further comprising:
applying, by the data security system, a machine learning model or data processing to fourth information to generate a third set of data records, the fourth information based on the first information and the second information, and wherein the third information is based on the third set of data records.

5. The method of claim 4, further comprising:
storing, by the data security system and in a second data store accessible to the data security system, the third set of data records in fifth format associated with the second data store; and
obtaining, at least in part, the third information from the second data store.

6. The method of claim 5, further comprising:
converting, by the data security system, the generated third set of data records from a sixth format associated with the machine learning model or data processing to the fifth format.

7. The method of claim 5, wherein the third information comprises a first subset of information retrieved from the first data store and a second subset of information retrieved from the second data store.

8. The method of claim 4, further comprising:
converting, by the data security system, at least a first portion of the first set of data records to a fifth format associated with the machine learning model or data processing; and
converting, by the data security system, at least a second portion of the second set of data records to the fifth format, wherein the fourth information comprises the converted at least the first portion and the converted at least the second portion.

9. The method of claim 4, further comprising:
obtaining, by the data security system from the computing device via the application programming interface, a request for the third information in the fourth format, wherein application of the machine learning model or data processing is based at least in part on the request.

10. The method of claim 4, wherein the fourth information is further based on a fourth set of data records stored in a second data store accessible to the data security system, the fourth set of data records stored in a fifth format associated with the second data store, the method further comprising:
converting a portion of the fourth information based on the second information and the third information from the third format to a sixth format associated with the machine learning model or data processing; and
converting the fourth set of data records from the fifth format to the sixth format.

11. The method of claim 10, further comprising:
storing by the data security system and at the second data store, the fourth set of data records in the fourth format comprising information extracted from the first set of data files.

12. The method of claim 1, wherein the third information comprises one or more first data records of the first set of data records and one or more second data records of the second set of data records.

13. The method of claim 1, wherein:
the first information comprises a subset of a cumulative amount of information of the first set of data files, and
the second information comprises a subset of a cumulative amount of information of the second set of data files.

14. The method of claim 1, further comprising:
identifying duplicate information in the first set of data files and the second set of data files, wherein the first information and the second information comprises a single copy of the duplicate information.

15. The method of claim 1, further comprising:
receiving, at the data security system, a third set of data files from a third security data source, the third set of data files having a fifth format; and
storing, by the data security system and at the first data store, a third set of data records comprising information extracted from the third set of data files, the third set of data records stored in the third format.

16. The method of claim 1, further comprising:
causing, by the data security system and via the application programming interface, display of the third information at a user interface of the computing device, wherein the computing device is associated with a client account of the data security system.

17. An apparatus, comprising:
one or more memories storing processor-executable code; and
one or more processors coupled with the one or more memories and individually or collectively operable to execute the code to cause the apparatus to:
obtain, at a data security system, a first set of data files from a first security data source, the first set of data files having a first format;
obtain, at the data security system, a second set of data files from a second security data source, the second set of data files having a second format different from the first format;
store, by the data security system and at a first data store accessible to the data security system, a first set of data records comprising first information extracted from the first set of data files, the first set of data records stored in a third format associated with the first data store;
store, by the data security system and at the first data store, a second set of data records comprising second information extracted from the second set of data files, the second set of data records stored in the third format; and
output by the data security system to a computing device via an application programming interface, third information in a fourth format associated with the application programming interface, the third information based on the second information and the third information.

18. The apparatus of claim 17, wherein the one or more processors are individually or collectively further operable to execute the code to cause the apparatus to:
obtain, by the data security system from the computing device and via the application programming interface, a request for the third information in the fourth format, wherein outputting the third information is based at least in part on the request.

19. The apparatus of claim 17, wherein the one or more processors are individually or collectively further operable to execute the code to cause the apparatus to:
output, by the data security system to the computing device or a second computing device via a second application programming interface, fourth information in a fifth format associated with the second application programming interface, the fourth information comprising at least a second portion of the second information and the third information.

20. A non-transitory computer-readable medium storing code, the code comprising instructions executable by one or more processors to:
obtain, at a data security system, a first set of data files from a first security data source, the first set of data files having a first format;
obtain, at the data security system, a second set of data files from a second security data source, the second set of data files having a second format different from the first format;
store, by the data security system and at a first data store accessible to the data security system, a first set of data records comprising first information extracted from the first set of data files, the first set of data records stored in a third format associated with the first data store;
store, by the data security system and at the first data store, a second set of data records comprising second information extracted from the second set of data files, the second set of data records stored in the third format; and
output by the data security system to a computing device via an application programming interface, third information in a fourth format associated with the application programming interface, the third information based on the second information and the third information.
